(19) United States
(12) Patent Application Publication
(10) Pub. No.: US 2003/0081883 A1
(43) Pub. Date: May 1, 2003

(54) Checker-board optical cross-connect

(75) Inventor: Mark F. Krol, Painted Post, NY (US)

Correspondence Address: WALL MARJAMA & BILINSKI, 101 SOUTH SALINA STREET, SUITE 400, SYRACUSE, NY, 13202, US

(73) Assignee: Corning, Inc.

(21) Appl. No.: 10/066,145

(22) Filed: Oct. 26, 2001

(51) Int. Cl. G02B 6/35

(52) U.S. Cl. 385/17; 385/16

(57) ABSTRACT

The present invention is a three-dimensional optical cross-connect switch that includes a first optical switching array and a second optical switching array. When combined, the first and second arrays have collimator tiles and beam steering tiles disposed in a checker-board arrangement. The maximum deflection angle of the switch is less than or equal to the maximum deflection angle of either individual switching array. The tiling scheme of the present invention effectively increases the port count of a three-dimensional optical cross-connect switch without increasing the angular deflection required to access all of the pixels in the switch.

### BACKGROUND OF THE INVENTION

1. Field of the Invention

The present invention relates generally to optical cross-connects, and particularly to three-dimensional optical cross-connects.

2. Technical Background

Over the past several decades, fiber optic technology has transformed the telecommunications industry. A decade ago, network designs included relatively low-speed transceiver electronics at each end of a communications link. Light signals were switched by being converted into electrical signals. The electrical signals were switched using electronic switches, and converted back again into light signals. The bandwidth of electronic switching equipment is in the Gigahertz range. On the other hand, the bandwidth of single mode fiber is in the Terahertz range. As the demand for bandwidth increased, network designers have sought ways to exploit the bandwidth in the 1550 nm region. Thus began the development of optically transparent switching fabrics.

Currently, optical designers are considering free-space plane-to-plane optical interconnects, often referred to as three-dimensional optical cross-connects (3D OXCs). 3D OXCs have the potential to make large scale N×N switching a reality. However, there are several drawbacks to large scale N×N switching fabrics. The fundamental limit on the minimum pitch associated with the beam steering arrays and collimator arrays is limited by the required diameter of the optical beam. The minimum separation between beams required to limit cross-talk will ultimately limit the path density of the free-space interconnect. Likewise, the maximum size of the collimator and beam steering arrays will be limited by the batch processing techniques used for fabrication.

Another factor limiting the size of switching arrays relates to the angular deflection required to fully access all of the pixels in a particular array. This is illustrated by the 3D OXC is shown in FIG. 1. OXC 100 includes tile 110 disposed in one plane and tile 120 aligned in a plane-to-plane relationship with tile 110. Tile 110 includes collimator array 102 and beam steering array 104. Tile 120 includes beam steering array 106 and collimator array 108. Light signal LS is directed into OXC 100 via collimator 1020. Pixel 1060 reflects light signal LS toward pixel 1040. Finally, light signal LS is directed out of OXC 100 via collimator 1080. In the example depicted in FIG. 1, the maximum angular deflection of light signal LS is shown. Clearly, as the physical dimensions of array 100 are increased, the required angular deflection to access all of the pixels in the array is also increased.

In one approach that is being considered, optical designers are tiling switching arrays to increase the physical dimensions of the optical cross-connect. As shown in FIG. 2, a second OXC 300 is layered over OXC 100. OXC 300 includes tile 310 disposed in one plane and tile 320 aligned plane-to-plane with tile 310. In FIG. 2, the maximum angular deflection of LS2 is shown. It is important to note that the maximum angular deflection of the composite switch (LS2) is much larger than the maximum angular deflection of LS1. As a result, this limits the potential size of an array. One way of reducing the magnitude of the maximum angular deflection is to increase the path length by increasing the separation distance “Z.” However, this is not viable because this will increase the required beam size, decreasing the path density through the interconnect accordingly. Finally, if the path length must be increased to accommodate additional tile layers, the system would no longer be scalable.

What is needed is a tiling scheme to effectively increase the port count of the interconnect without increasing the angular deflection required to access all of the pixels in the switch.

### SUMMARY OF THE INVENTION

The present invention addresses the needs identified above. The present invention includes a tiling scheme that effectively increases the port count of a three-dimensional optical cross-connect switch without increasing the angular deflection required to access all of the pixels in the switch.

One aspect of the present invention is a three-dimensional optical cross-connect switch. The switch includes a first optical switching array having a first tile disposed in a first plane, and a second tile aligned plane-to-plane with the first tile in a second plane. The first tile includes a first collimator array disposed adjacent to a first beam steering array. The second tile includes a second collimator array disposed adjacent to a second beam steering array. The first optical switching array is characterized by a first array maximum deflection angle. The switch also includes a second optical switching array having a third tile disposed in the first plane, and a fourth tile aligned plane-to-plane with the third tile in the second plane. The third tile includes a third collimator array disposed adjacent to a third beam steering array. The fourth tile includes a fourth collimator array disposed adjacent to a fourth beam steering array. The maximum deflection angle of the switch is less than or equal to the first array maximum deflection angle.

In another aspect, the present invention includes a three-dimensional optical cross-connect switch. The switch includes a first optical switching array and a second optical switching array. The first optical switching array includes a first tile having a first collimator array disposed adjacent to a first beam steering array, and a second tile having a second collimator array disposed adjacent to a second beam steering array. The second collimator array is aligned plane-to-plane with the first beam steering array. The second beam steering array is aligned plane-to-plane with the first collimator array. The second optical switching array includes a third tile having a third collimator array disposed adjacent to a third beam steering array, and a fourth tile having a fourth collimator array disposed adjacent to a fourth beam steering array. The fourth collimator array is aligned plane-to-plane with the third beam steering array. The fourth beam steering array is aligned plane-to-plane with the third collimator array. The third beam steering array is disposed adjacent the first collimator array to form a checkerboard pattern.

In another aspect, the present invention includes a three-dimensional optical cross-connect switch. The switch has a first optical switching array including a first tile disposed in a first plane, and a second tile disposed in a second plane parallel to the first plane. The first tile includes a first collimator array disposed adjacent to a first beam steering array. The second tile includes a second collimator array disposed adjacent to a second beam steering array. The first beam steering array and the second beam steering array each have N-steerable pixel elements. The first optical switching array is characterized by an array maximum deflection angle that is required to access each pixel in the first optical switching array. A second optical switching array is coupled to the first optical switching array. The second optical switching array includes a third tile disposed in the first plane and a fourth tile disposed in the second plane. The third tile includes a third collimator array disposed adjacent to a third beam steering array. The fourth tile includes a fourth collimator array disposed adjacent to a fourth beam steering array. The third beam steering array and the fourth beam steering array each have N-steerable pixel elements. The maximum deflection angle of the switch that is required to access each pixel in the cross-connect switch is less than or equal to the first array maximum deflection angle.

In another aspect, the present invention includes a method for expanding a switching capacity of a three-dimensional optical cross-connect switch. The method includes providing a first optical switching array. The first optical switching array includes a first tile disposed in a first plane and a second tile aligned plane-to-plane with the first tile in a second plane. The first tile includes a first collimator array disposed adjacent to a first beam steering array. The second tile includes a second collimator array disposed adjacent to a second beam steering array. The first optical switching array is characterized by an array maximum deflection angle. A second optical switching array is provided that includes a third tile disposed in the first plane, and a fourth tile aligned plane-to-plane with the third tile in the second plane. The third tile includes a third collimator array disposed adjacent to a third beam steering array. The fourth tile includes a fourth collimator array disposed adjacent to the fourth beam steering array. The first optical switching array is coupled to the second optical switching array. The maximum deflection angle of the three-dimensional optical cross-connect switch is less than or equal to the array maximum deflection angle.

In another aspect, the present invention includes a method for expanding a switching capacity of a three-dimensional optical cross-connect switch. The method includes providing a first optical switching array. The first optical switching array includes a first tile having a first collimator array disposed adjacent to a first beam steering array, and a second tile having a second collimator array disposed adjacent to a second beam steering array. The second collimator array is aligned plane-to-plane with the first beam steering array. The second beam steering array is aligned plane-to-plane with the first collimator array. The first optical switching array is characterized by a first array maximum deflection angle. A second optical switching array is provided that includes a third tile and a fourth tile. The third tile has a third collimator array disposed adjacent to a third beam steering array. The fourth tile has a fourth collimator array disposed adjacent to a fourth beam steering array. The fourth collimator array is aligned plane-to-plane with the third beam steering array, and the fourth beam steering array is aligned plane-to-plane with the third collimator array. The third beam steering array is disposed adjacent the first collimator array in a checkerboard pattern. The first optical switching array is coupled to the second optical switching array. The maximum deflection angle of the three-dimensional optical cross-connect switch is less than or equal to the array maximum deflection angle.

In another aspect, the present invention includes a method for switching optical signals in a three-dimensional optical cross-connect switch. The switch includes a first optical switching array having a first tile disposed in a first plane, and a second tile aligned plane-to-plane with the first tile in a second plane. The first tile includes a first collimator array disposed adjacent to a first beam steering array. The second tile includes a second collimator array disposed adjacent to a second beam steering array. The first optical switching array is characterized by an array maximum deflection angle. The method includes providing a second optical switching array having a third tile disposed in the first plane, and a fourth tile aligned plane-to-plane with the third tile in the second plane. The third tile includes a third collimator array disposed adjacent to a third beam steering array. The fourth tile includes a fourth collimator array disposed adjacent to the fourth beam steering array. The first optical switching array is coupled to the second optical switching array such that the maximum deflection angle of the three-dimensional optical cross-connect switch is less than or equal to the array maximum deflection angle. The light signal is directed into the first collimator array causing the light signal to propagate toward the second plane

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block diagram of a three-dimensional optical cross-connect having one tiled switching array;

FIG. 2 is a block diagram of a three-dimensional optical cross-connect having two tiled switching array;

FIG. 3 is a block diagram of the checker-board three-dimensional optical cross-connect architecture in accordance with the present invention;

FIG. 4 is a chart comparing the performance of the checker-board three-dimensional optical cross-connect architecture depicted in FIG. 3 with the three-dimensional optical cross-connect depicted in FIG. 2;

FIG. 5 is a detail view of the gimbaled pixel employed in the beam steering arrays of the present invention;

FIG. 6 is a detail view of a pixel mirror element employed in the gimbaled pixel shown in FIG. 5;

FIG. 7 and FIG. 8 are representative examples of an N x N optical cross-connect in accordance with the present invention; and

FIG. 9 and FIG. 10 are representative examples of an N x N optical cross-connect with optical shared protection in accordance with the present invention

### DETAILED DESCRIPTION

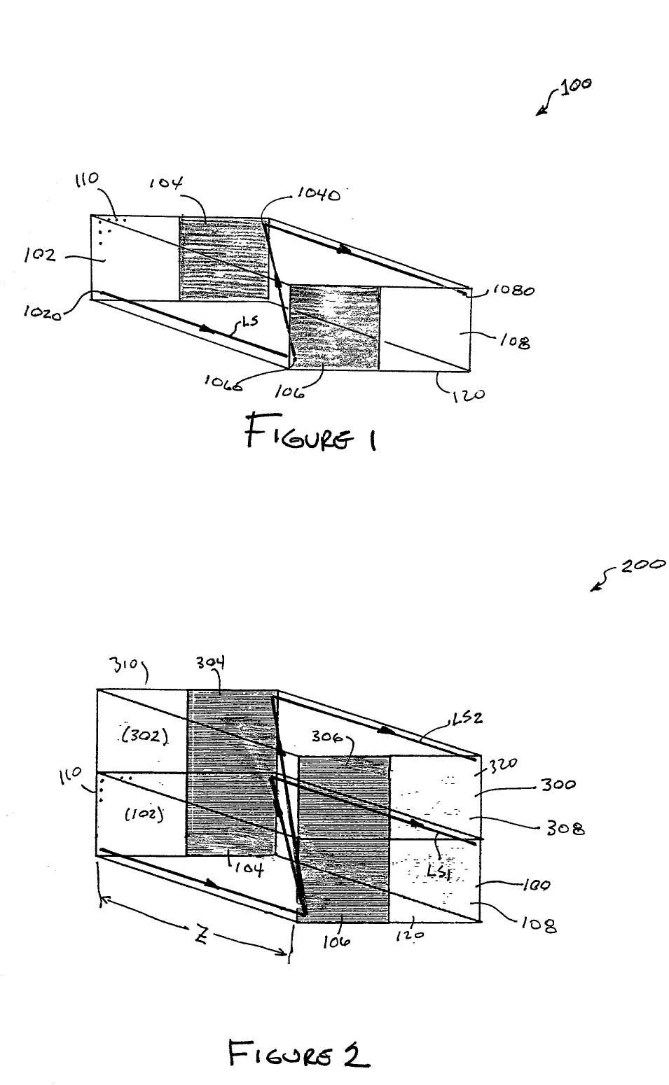

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the three-dimensional optical cross-connect switch of the present invention is shown in FIG. 1, and is designated generally throughout by reference numeral 10.

In accordance with the invention, the present invention for a three-dimensional optical cross-connect switch includes a first optical switching array having a first tile disposed in a first plane, and a second tile aligned plane-to-plane with the first tile in a second plane. The first tile includes a first collimator array disposed adjacent to a first beam steering array. The second tile includes a second collimator array disposed adjacent to a second beam steering array. The first optical switching array is characterized by a first array maximum deflection angle that is required to access all of the pixels in the first array. A second optical switching array includes a third tile disposed in the first plane, and a fourth tile aligned plane-to-plane with the third tile in the second plane. The third tile includes a third collimator array disposed adjacent to a third beam steering array. The fourth tile including a fourth collimator array disposed adjacent to a fourth beam steering array. The switch maximum deflection angle is less than or equal to the first array maximum deflection angle. Thus, the tiling scheme of the present invention effectively increases the port count of a three-dimensional optical cross-connect switch without increasing the angular deflection required to access all of the pixels in the switch.

As embodied herein, and depicted in FIG. 3, a block diagram of checker-board 3D OXC 10 in accordance with the present invention is disclosed. OXC 10 includes switching array 100 coupled to switching array 300. Switching array 100 includes tile 110 and tile 120, aligned in a plane-to-plane relationship with tile 110. Tile 110 includes collimator array 12 disposed adjacent to beam steering array 14. Tile 120 includes collimator array 18 disposed adjacent to beam steering array 16. Collimator array 12 is aligned with beam steering array 16, and collimator array 18 is aligned with beam steering array 14. Switching array 300 includes tile 310 and tile 320, aligned in a plane-to-plane relationship with tile 310. Tile 310 includes collimator array 20 disposed adjacent to beam steering array 22. Tile 320 includes collimator array 24 disposed adjacent to beam steering array 26. Collimator array 22 is aligned with beam steering array 26, whereas collimator array 24 is aligned with beam steering array 20.

As shown, collimator array 12, collimator array 22, beam steering array 14, and beam steering array 20 are arranged in a checker-board pattern. Likewise, collimator array 18, collimator array 24, beam steering array 16, and beam steering array 26 are also arranged in a checker-board pattern. As shown by comparing the path of light signal LS1 to the path of light signal LS2, there is no increase in the overall maximum angular deflection of OXC 10 vis à vis the maximum angular deflection of switching array 100. Thus, the checker-board tiling scheme of the present invention effectively increases the port count without increasing the angular deflection required to access all of the beam steering pixels.

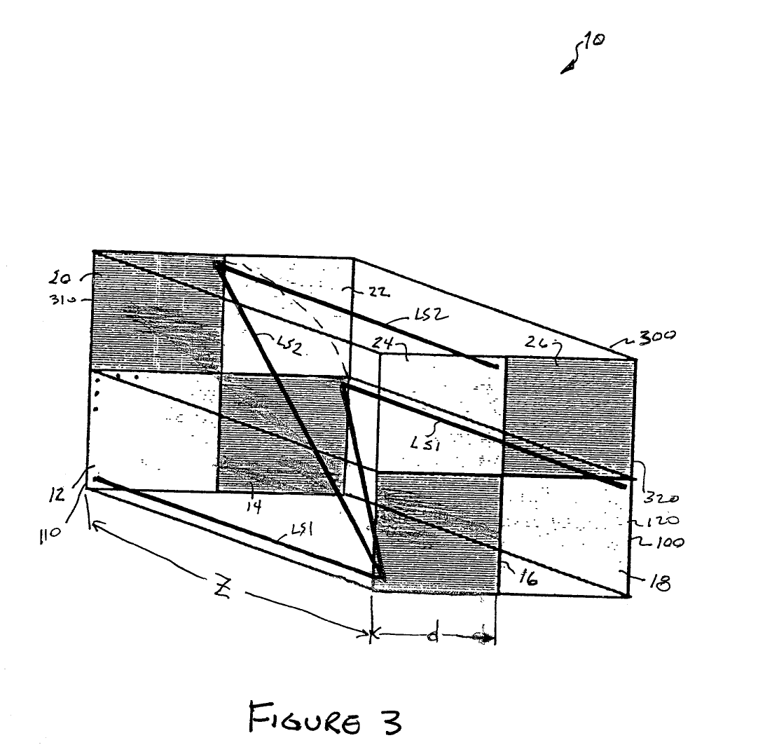

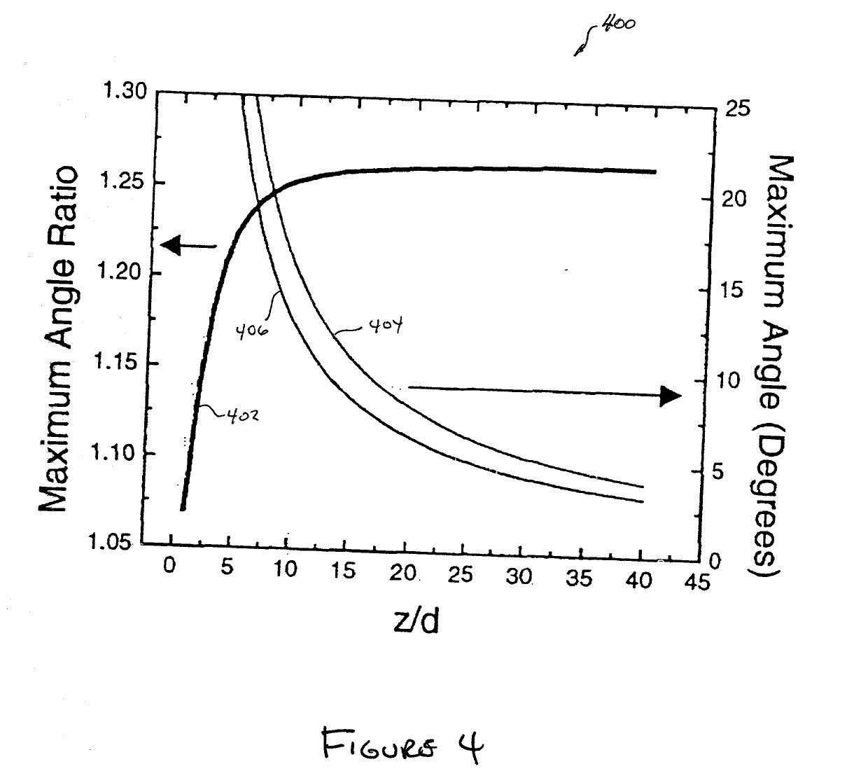

FIG. 4 compares the performance of checker-board 3D OXC 10 depicted in FIG. 3 to 3D OXC 200, depicted in FIG. 2. Plot line 402 shows the maximum angle ratio as a function of the physical dimensions of OXC 10. Plot line 404 shows the maximum angle of OXC 200 (FIG. 2) as a function of the physical dimensions of OXC 200. Plot line 406 shows the maximum angle of OXC 10 (FIG. 3) as a function of the physical dimensions of OXC 10. It is clear from FIG. 4 that for zid ratios of 10 or greater, the tiling scheme used in FIG. 2 requires a 25% growth in the angular deflection of the beam steering arrays. On the other hand, the checker-board architecture depicted in FIG. 3 requires no growth in angular deflection because of the inherent symmetry of the design. Thus, system designers can upgrade from a single tier system to the system depicted in FIG. 3 without changing the geometry of the device because the maximum angle is the same; whereas system designers cannot upgrade from the system depicted in FIG. 1 to the system depicted in FIG. 2 without changing the geometry of the overall module design. In other words, the migration from FIG. 1 to FIG. 2 requires the replacement of the system of FIG. 1 with the system of FIG. 2 because the geometries are necessarily different. On the other hand, the present invention provides system designers with the flexibility of expanding the system of FIG. 1 to arrive at the system depicted in FIG. 3, without having to replace the FIG. 1 system. This results in significant cost savings.

As embodied herein and depicted in FIG. 5, a detail view of the gimbaled pixel assembly 500 employed in the beam steering arrays of the present invention is disclosed. In one embodiment, the beam steering arrays include 10×10=100 pixel assemblies 500. Obviously, this means that the collimator arrays are also 10×10 arrays as well. One of ordinary skill in the art will recognize that the size of these arrays is variable, dependent on the factors discussed above in the Technical background.

Assembly 500 includes reflective pixel element 502. Pixel 502 is coupled to frame member 508 via beam 504 and beam 506. Beam 504 and beam 506 allow pixel element 502 to rotate around the y-axis. Frame member 508 is coupled to substrate 514 via beam 510 and beam 512. Beam 510 and beam 512 allow frame member 508 to rotate about the x-axis. Thus, pixel element 502 is steerable with 2-degrees of freedom. As shown in FIG. 5, pixel assembly 500 is suspended over trench 520. An electrostatic actuator assembly (not shown) is disposed under pixel assembly 500 in trench 520. The electrostatic actuator assembly is coupled to a control system. The actuator assembly includes an electrode disposed under each beam 504, 506, 510, and 512) To cause a rotation around beam 504 and beam 506, the electrodes under beam 510 and 512 are actuated by applying an actuation voltage. To cause a rotation around beam 510 and beam 512, the electrodes under beam 504 and beam 506 are actuated by applying an actuation voltage. The beams twist when they are rotated and become springs that supply a balancing force to the applied electro-static forces. The beams also supply a return force when the applied voltage is reduced.

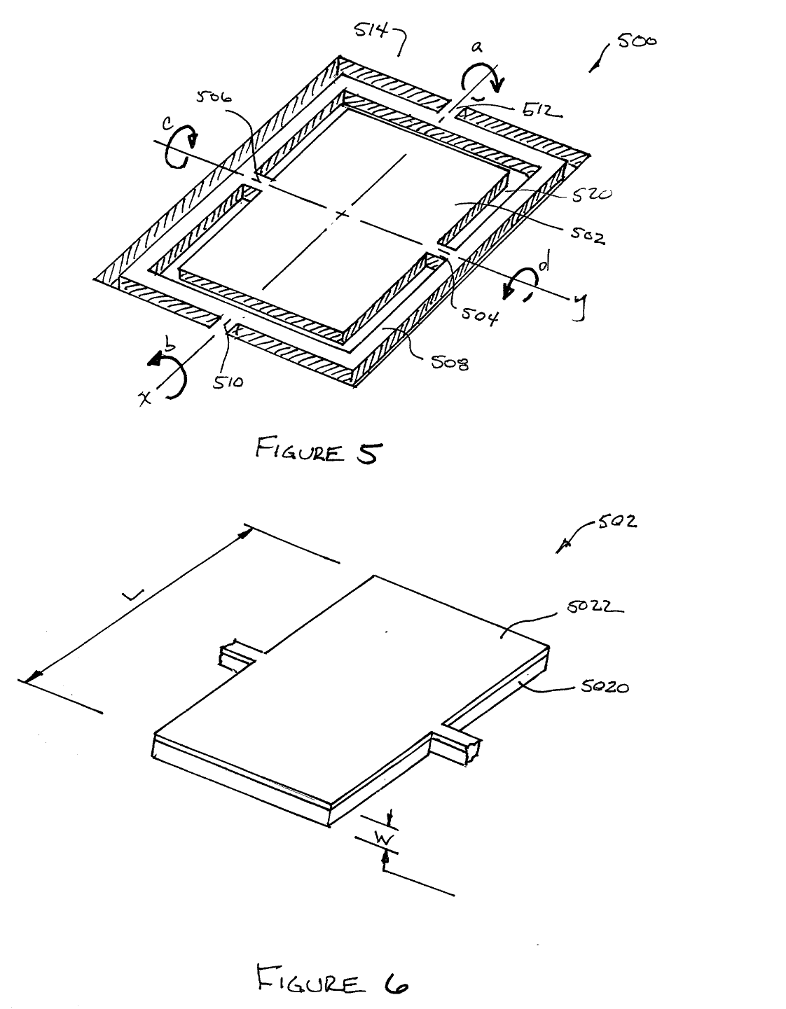

As embodied herein and depicted in FIG. 6, a detail view of pixel element 502 employed in gimbaled pixel assembly 500 is disclosed. Pixel element 502 includes reflective surface 5022 disposed on substrate 5020. It will be apparent to those of ordinary skill in the pertinent art that modifications and variations can be made to pixel element 502 of the present invention depending on the beam size of incident light signals. For example, the side dimension “L” of pixel element 502 may range between 200 μm to 1 mm. The width “W” of pixel element 502 is usually below 10 μm, and typically about 5 μm. One of ordinary skill in the art will also recognize that pixel element 502 can be formed using a number of photolithographic techniques, such as MEMS micro-machining. In one embodiment, substrate 5020 is formed using a silicon or polysilicon material. Reflective layer 5022 is formed by depositing a layer of gold over substrate 5020.

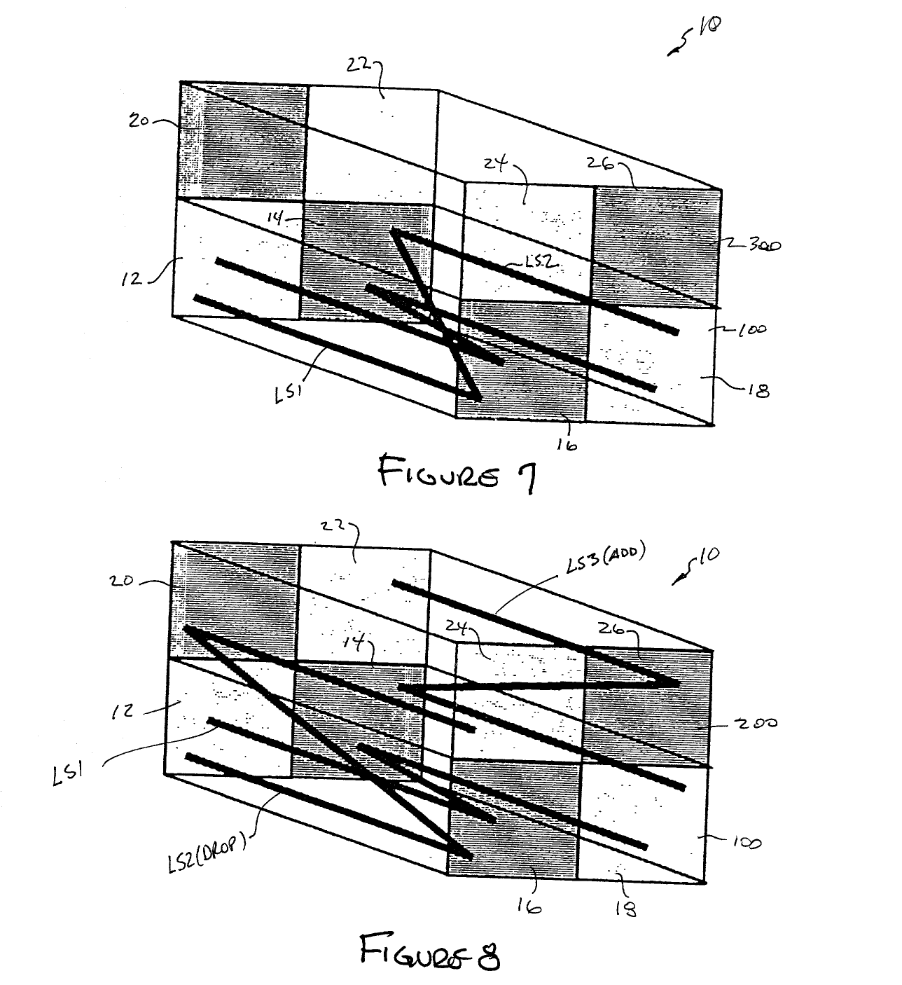

FIG. 7 and FIG. 8 are representative examples of an N x N optical cross-connect in accordance with an ADD/DROP embodiment of the present invention. In FIG. 7, both light signal LS1 and light signal LS 2 are cross-connected in pass-through in array 100. In FIG. 8, the ADD/DROP functionality of OXC 10 is illustrated. Light signal LS 1 is cross-connected in pass-through, whereas light signal LS2 is dropped from the traffic flow of array 100, and light signal LS3 is added to the traffic flow of array 100.

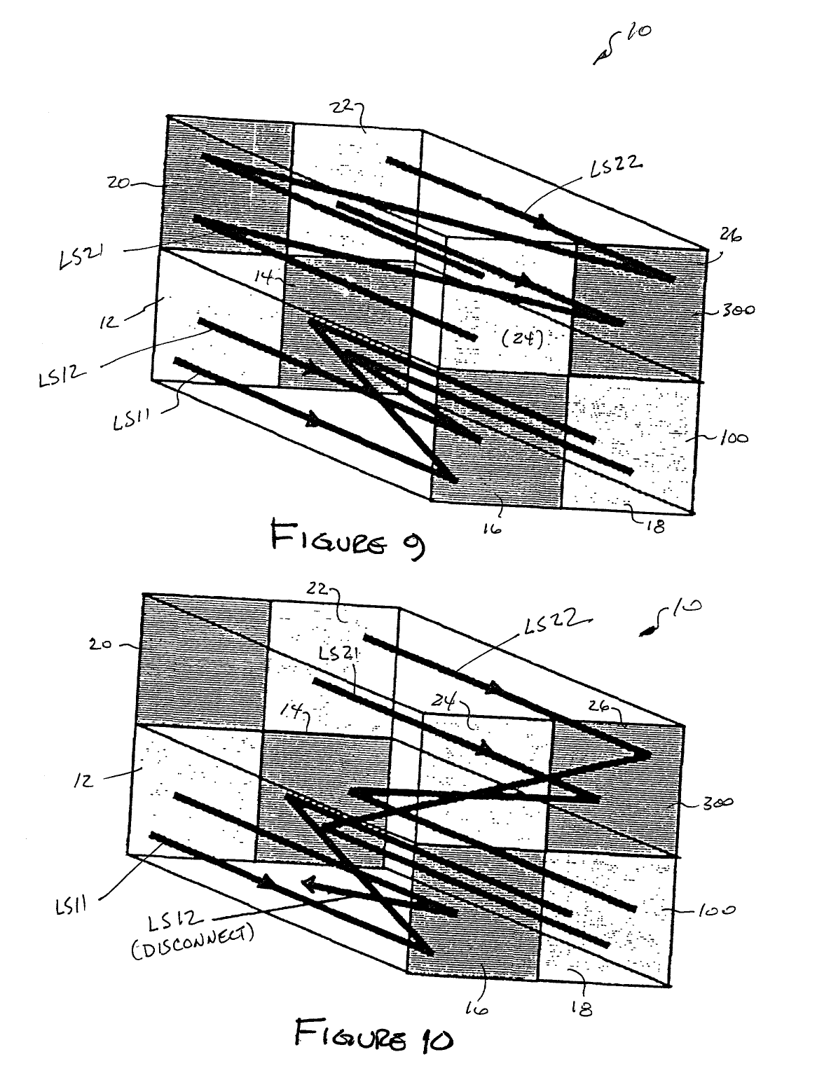

FIG. 9 and FIG. 10 are representative examples of an N×N optical cross-connect with optical shared protection in accordance with a third embodiment of the present invention. In FIG. 9, light signal LS11 and light signal LS12 comprise the west bound traffic in an optical shared protection ring environment. Light signal LS21 and light signal LS22 comprise the east bound traffic. In this example, a fault has developed in the east bound ring due to a fiber cut, a faulty switching node, or for some other reason. Light signal LS12 carries low-priority traffic. As shown in FIG. 10, LS 12 is disconnected. East bound light signal LS21 and east bound light signal LS22 are re-routed by beam steering array 26. LS21 and LS22 are directed toward beam steering array 14 instead of array 20. Light signal LS21 and light signal LS22 are directed out of collimator array 18 and into the west bound traffic flow. Thus, LS21 and LS 22 are re-routed around the cause of the fault in the ring.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A three-dimensional optical cross-connect switch, the switch comprising:
a first optical switching array including a first tile disposed in a first plane and a second tile aligned plane-to-plane with the first tile in a second plane, the first tile including a first collimator array disposed adjacent to a first beam steering array and the second tile including a second collimator array disposed adjacent to a second beam steering array, the first optical switching array being characterized by a first array maximum deflection angle; and
a second optical switching array including a third tile disposed in the first plane and a fourth tile aligned plane-to-plane with the third tile in the second plane, the third tile including a third collimator array disposed adjacent to a third beam steering array, and the fourth tile including a fourth collimator array disposed adjacent to a fourth beam steering array, whereby a switch maximum deflection angle is less than or equal to the first array maximum deflection angle.

2. The switch of claim 1, wherein the first collimator array, the third collimator array, the first beam steering array, and the third beam steering array are arranged in a checker-board pattern.

3. The switch of claim 1, wherein the second collimator array, the fourth collimator array, the second beam steering array, and the fourth beam steering array are arranged in a checker-board pattern.

4. The switch of claim 1 wherein the second optical switching array is characterized by a second array maximum deflection angle.

5. The switch of claim 4, wherein the switch maximum deflection angle is less than or equal to the second array maximum deflection angle.

6. The switch of claim 4, wherein the first array maximum deflection angle is equal to the second array maximum deflection angle.

7. The switch of claim 1, wherein each of the first beam steering array, the second beam steering array, the third beam steering array, and the fourth beam steering array include at least one beam steering pixel.

8. The switch of claim 7, wherein the at least one beam steering panel includes an N x N array of beam steering pixels.

9. The switch of claim 8, further comprising a control system coupled to the beam steering panel, the control system being configured to provide a control signal to each pixel in the N×N array of beam steering pixels.

10. The switch of claim 7, wherein the at least one beam steering pixel includes a MEMS mirror element.

11. The switch of claim 7, wherein the at least one beam steering pixel includes a gimbaled MEMS mirror element having at least two-degrees of beam steering freedom.

12. The switch of claim 7, wherein the at least one beam steering pixel includes a plurality of individually steerable mirror elements.

13. The switch of claim 12, further comprising a control system coupled to the beam steering panel, the control system being configured to provide a control signal to each of the individually steerable mirror elements.

14. The switch of claim 7, wherein each of the first collimator array, the second collimator array, the third collimator array, and the fourth collimator array include at least one collimator coupled to an optical fiber.

15. The switch of claim 14, wherein the at least one collimator panel includes an N x N array of collimators.

16. The switch of claim 1, wherein the switch is characterized by a z/d ratio greater than ten (10), z being a distance between the first plane and the second plane, and d being a width of a beam steering array.

17. A three-dimensional optical cross-connect switch, the switch comprising:
a first optical switching array including a first tile having a first collimator array disposed adjacent to a first beam steering array and a second tile having a second collimator array disposed adjacent to a second beam steering array, the second collimator array being aligned plane-to-plane with the first beam steering array and the second beam steering array being aligned plane-to-plane with the first collimator array; and
a second optical switching array including a third tile having a third collimator array disposed adjacent to a third beam steering array, and a fourth tile having a fourth collimator array disposed adjacent to a fourth beam steering array, the fourth collimator array being aligned plane-to-plane with the third beam steering array and the fourth beam steering array being aligned plane-to-plane with the third collimator array, whereby the third beam steering array is disposed adjacent the first collimator array.

18. The switch of claim 17, wherein the first collimator array, the third collimator array, the first beam steering array, and the third beam steering array are arranged in a checker-board pattern.

19. The switch of claim 17, wherein the second collimator array, the fourth collimator array, the second beam steering array, and the fourth beam steering array are arranged in a checker-board pattern.

20. The switch of claim 17, wherein the second optical switching array is characterized by a second array maximum deflection angle.

21. The switch of claim 20, wherein the switch maximum deflection angle is less than or equal to the second array maximum deflection angle.

22. The switch of claim 20, wherein the first array maximum deflection angle is equal to the second array maximum deflection angle.

23. The switch of claim 17, wherein the switch is characterized by a z/d ratio greater than ten (10), z being a distance between the first plane and the second plane, and d being a width of a beam steering array.

24. The switch of claim 17, wherein each of the first beam steering array, the second beam steering array, the third beam steering array, and the fourth beam steering array include at least one beam steering pixel.

25. The switch of claim 25, wherein the at least one beam steering panel includes an N×N array of beam steering pixels.

26. The switch of claim 25, wherein the at least one beam steering pixel includes a MEMS mirror element.

27. The switch of claim 25, wherein the at least one beam steering pixel includes a gimbaled MEMS mirror element having at least two-degrees of beam steering freedom.

28. A three-dimensional optical cross-connect switch, the switch comprising:
a first optical switching array including a first tile disposed in a first plane and a second tile disposed in a second plane parallel to the first plane, the first tile including a first collimator array disposed adjacent to a first beam steering array, the second tile having a second collimator array disposed adjacent to a second beam steering array, the first beam steering array and the second beam steering array each having N-steerable pixel elements, the first optical switching array being characterized by an array maximum deflection angle required to access each pixel in the first optical switching array; and
a second optical switching array coupled to the first optical switching array, the second optical switching array including a third tile disposed in the first plane and a fourth tile disposed in the second plane, the third tile including a third collimator array disposed adjacent to a third beam steering array, the fourth tile including a fourth collimator array disposed adjacent to a fourth beam steering array, the third beam steering array and the fourth beam steering array each having N-steerable pixel elements, whereby a switch maximum deflection angle required to access each pixel in the cross-connect switch is less than or equal to the first array maximum deflection angle.

29. The switch of claim 29, wherein the first collimator array, the third collimator array, the first beam steering array, and the third beam steering array are arranged in a checker-board pattern.

30. The switch of claim 29, wherein the second collimator array, the fourth collimator array, the second beam steering array, and the fourth beam steering array are arranged in a checker-board pattern.

31. The switch of claim 29, wherein the second optical switching array is characterized by a second array maximum deflection angle.

32. The switch of claim 32, wherein the switch maximum deflection angle is less than or equal to the second array maximum deflection angle.

33. The switch of claim 32, wherein the first array maximum deflection angle is equal to the second array maximum deflection angle.

34. The switch of claim 29, wherein the switch is characterized by a z/d ratio greater than ten (10), z being a distance between the first plane and the second plane, and d being a width of a beam steering array.

35. The switch of claim 29, wherein each of the first beam steering array, the second beam steering array, the third beam steering array, and the fourth beam steering array include at least one beam steering pixel.

36. The switch of claim 36, wherein the at least one beam steering panel includes an N×N array of beam steering pixels.

37. The switch of claim 36, wherein the at least one beam steering pixel includes a MEMS mirror element.

38. The switch of claim 36, wherein the at least one beam steering pixel includes a gimbaled MEMS mirror element having at least two-degrees of beam steering freedom.

39. A method for expanding a switching capacity of a three-dimensional optical cross-connect switch, the method comprising:
providing a first optical switching array including a first tile disposed in a first plane and a second tile aligned plane-to-plane with the first tile in a second plane, the first tile including a first collimator array disposed adjacent to a first beam steering array and the second tile including a second collimator array disposed adjacent to a second beam steering array, the first optical switching array being characterized by an array maximum deflection angle;
providing a second optical switching array including a third tile disposed in the first plane and a fourth tile aligned plane-to-plane with the third tile in the second plane, the third tile including a third collimator array disposed adjacent to a third beam steering array, and the fourth tile including a fourth collimator array disposed adjacent to the fourth beam steering array; and
coupling the first optical switching array to the second optical switching array, whereby a maximum deflection angle of the three-dimensional optical cross-connect switch is less than or equal to the array maximum deflection angle.

40. The method of claim 40, wherein the first collimator array, the third collimator array, the first beam steering array, and the third beam steering array are arranged in a checker-board pattern.

41. The method of claim 40, wherein the second collimator array, the fourth collimator array, the second beam steering array, and the fourth beam steering array are arranged in a checker-board pattern.

42. The method of claim 40, wherein the second optical switching array is characterized by a second array maximum deflection angle.

43. The method of claim 44, wherein the method maximum deflection angle is less than or equal to the second array maximum deflection angle.

44. The method of claim 44, wherein the first array maximum deflection angle is equal to the second array maximum deflection angle.

45. The method of claim 40, wherein the method is characterized by a z/d ratio greater than ten (10), z being a distance between the first plane and the second plane, and d being a width of a beam steering array.

46. A method for expanding a switching capacity of a three-dimensional optical cross-connect switch, the method comprising:
providing a first optical switching array including a first tile having a first collimator array disposed adjacent to a first beam steering array and a second tile having a second collimator array disposed adjacent to a second beam steering array, the second collimator array being aligned plane-to-plane with the first beam steering array and the second beam steering array being aligned plane-to-plane with the first collimator array, the first optical switching array being characterized by a first array maximum deflection angle;
providing a second optical switching array including a third tile having a third collimator array disposed adjacent to a third beam steering array, and a fourth tile having a fourth collimator array disposed adjacent to a fourth beam steering array, the fourth collimator array being aligned plane-to-plane with the third beam steering array and the fourth beam steering array being aligned plane-to-plane with the third collimator array, whereby the third beam steering array is disposed adjacent the first collimator array; and
coupling the first optical switching array to the second optical switching array, whereby a maximum deflection angle of the three-dimensional optical cross-connect switch is less than or equal to the array maximum deflection angle.

47. A method for switching optical signals in a three-dimensional optical cross-connect switch, the switch including a first optical switching array including a first tile disposed in a first plane and a second tile aligned plane-to-plane with the first tile in a second plane, the first tile including a first collimator array disposed adjacent to a first beam steering array and the second tile including a second collimator array disposed adjacent to a second beam steering array, the first optical switching array being characterized by an array maximum deflection angle, the method comprising:
providing a second optical switching array including a third tile disposed in the first plane and a fourth tile aligned plane-to-plane with the third tile in the second plane, the third tile including a third collimator array disposed adjacent to a third beam steering array, and the fourth tile including a fourth collimator array disposed adjacent to the fourth beam steering array;
coupling the first optical switching array to the second optical switching array, whereby a maximum deflection angle of the three-dimensional optical cross-connect switch is less than or equal to the array maximum deflection angle; and
directing the light signal into the first collimator array, whereby the light signal propagates toward the second plane.

48. The method of claim 48, wherein the second beam steering array reflects the light signal toward the first plane.

49. The method of claim 49, wherein the first beam steering array directs the light signal to an output port via the second collimator array.

50. The method of claim 49, wherein the first beam steering array directs the light signal to an output port via the fourth collimator array.

51. The method of claim 48, wherein the fourth beam steering array reflects the light signal toward the first plane.

52. The method of claim 52, wherein the first beam steering array directs the light signal to an output port via the second collimator array.

53. The method of claim 52, wherein the first beam steering array directs the light signal to an output port via the fourth collimator array.
